(19) United States
(12) Patent Application Publication
(10) Pub. No.: US 2012/0024412 A1
(43) Pub. Date: Feb. 2, 2012

(54) ARTICULATED PIPING FOR FLUID TRANSPORT APPLICATIONS

(75) Inventors: Christopher A. Bertelo, Doylestown, PA (US); Anthony Decarmine, Lebanon, CT (US)

(73) Assignee: Arkema Inc, King of Prussia, PA (US)

(21) Appl. No.: 13/260,426

(22) PCT Filed: Mar. 24, 2010
(86) PCT No.: PCT/US10/28417

§ 371 Date: Sep. 26, 2011

Related U.S. Application Data
(60) Provisional application No. 61/164,113, filed on Mar. 27, 2009.

(51) Int. Cl. F16L 57/00

(52) U.S. Cl. 138/110

(57) ABSTRACT

An articulated pipeline assembly for the transport of fluids including a fluid conduit for transporting fluid and an articulating shell assembly that is positioned to encapsulate the fluid conduit. The articulating shell assembly includes a plurality of articulating shell segments, each articulating shell segment comprising both a ball and a socket, wherein the ball of each articulating shell segment is engaged with a socket of an adjacent articulating shell segment to form a ball and socket joint. Each articulating shell segment is configured to rotate with respect to an adjacent articulating shell segment by virtue of the ball and socket joint.

### TECHNICAL FIELD

This invention relates to articulated piping for the transport of fluids.

### BACKGROUND OF THE INVENTION

Piping is employed for distributing fluids over long distances. The exterior surfaces of the piping may be exposed to inhospitable environments, such as open desert, sea water, jungle, uncontrolled chemical spaces, or an environment maintained at an elevated temperature or an elevated pressure, for example. The interior surfaces of the piping may be exposed to abrasive and/or corrosive fluid that is distributed through the fluid passageway of the piping. In the interest of convenience and storage, operators may prefer to arrange such piping on a spool for easy deployment and storage. In view of the foregoing, there exists a need to develop and improve upon fluid transport piping in the interest of storage, performance, convenience, manufacturability and safety.

### SUMMARY OF THE INVENTION

According to one aspect of the invention, an articulated pipeline assembly for the transport of fluids is provided. The articulated pipeline assembly comprises a fluid conduit for transporting fluid and an articulating shell assembly that is positioned to encapsulate the fluid conduit. The articulating shell assembly includes a plurality of articulating shell segments, whereby each articulating shell segment comprises both a ball and a socket. The ball of each articulating shell segment is engaged with a socket of an adjacent articulating shell segment to form a ball and socket joint and the socket of each articulating shell segment is engaged with a ball of an adjacent articulating shell segment to form a ball and socket joint. Each articulating shell segment is configured to rotate with respect to an adjacent articulating shell segment by virtue of the ball and socket joint.

According to another aspect of the invention, each articulating shell segment includes two discrete, separable components that are configured to be mated together.

These and other aspects of the present invention will become clear from the detailed discussion below when taken into consideration with the drawings. It is to be understood that the following discussion is intended merely to illustrate the preferred embodiments of the present invention.

### BRIEF DESCRIPTION OF THE FIGURES

The invention is best understood from the following detailed description when read in connection with the accompanying drawing. It is emphasized that, according to common practice, the various features of the drawing are not to scale. Included in the drawing are the following figures:

FIG. 1 depicts an elevation view of a segment of a pipeline comprising a fluid conduit encapsulated within an articulated shell assembly, according to one exemplary embodiment of the invention, wherein a portion of the articulated shell is cut-away to reveal the fluid conduit.

FIG. 2 depicts a cross-sectional view of the pipeline of FIG. 1 taken along the lines 2-2.

FIG. 3A depicts an elevation view of a segment of a pipeline comprising a fluid conduit encapsulated within an articulated shell assembly, wherein each articulated shell segment is a two-piece assembly, according to yet another exemplary embodiment of the invention.

FIG. 3B depicts a cross-sectional view of the pipeline of FIG. 3A taken along the lines 3B-3B.

### DETAILED DESCRIPTION OF THE INVENTION

This invention will now be described with reference to several embodiments selected for illustration in the drawings. It will be appreciated that the scope and spirit of the invention are not limited to the illustrated embodiments.

As used herein, the term fluid is non-limiting and may refer to any type of fluid such as liquids, gasses or slurries, for example.

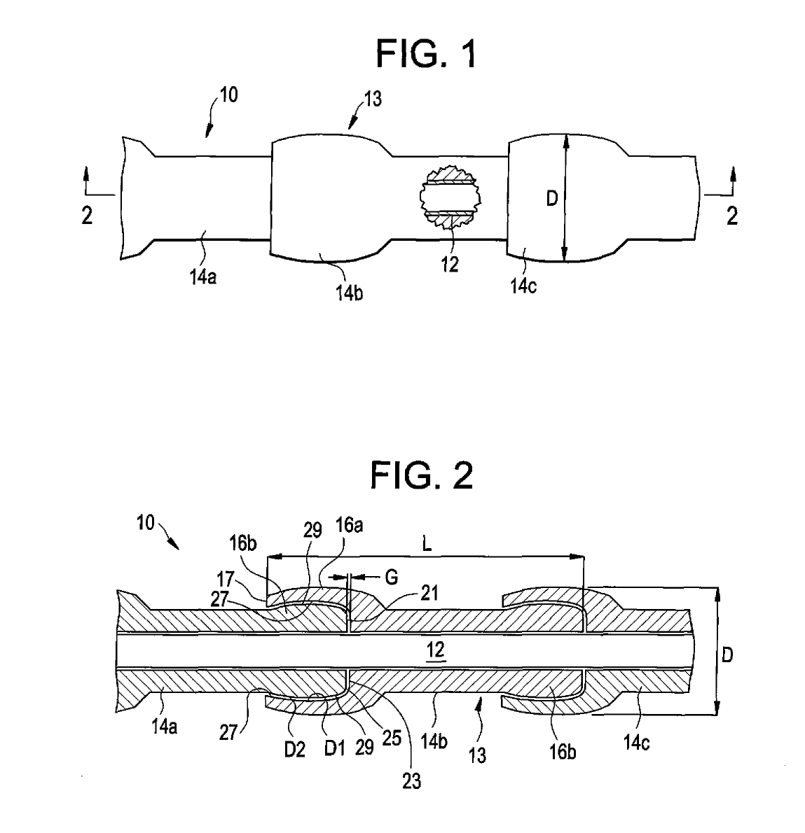

FIG. 1 depicts an elevation view of a segment of a pipeline comprising a fluid conduit encapsulated within an articulated shell assembly, according to one exemplary embodiment of the invention. The segment of the pipeline is denoted by the numeral ‘10.’ The pipeline 10 generally comprises a flexible fluid conduit 12 encapsulated within an articulated shell assembly 13. The articulated shell assembly 13 comprises a series of interlinked articulated shell segments 14a-14c (collectively referred to as an articulated shell segments 14). In FIG. 1, a portion of the shell segment 14b is cutaway to reveal the fluid conduit 12.

FIG. 2 depicts a cross-sectional view of the pipeline 10 of FIG. 1 taken along the lines 2-2. The fluid conduit 12 is a hollow structure for transporting fluid that is encased in the articulated shell assembly 13. Each articulated shell segment 14 is a rigid body that is configured to protect the fluid conduit 12 from outside abrasion and support the fluid conduit 12 when internal pressures are relatively high.

Each shell segment 14 is defined by a substantially cylindrical hollow body. According to this exemplary embodiment, the shell segments 14 are unitary, however, in another embodiment each shell segment is composed of two pieces. Both the shape and size of each shell segment 14 are substantially equivalent.

The shell segments 14a-14c interlock through a series of ball and socket joints. Each shell segment 14 includes a ball 16b on one end and a socket 16a on an opposing end thereof. Each ball 16b is configured for mating with a socket 16a of an adjacent shell segment.

According to one exemplary method of assembling the articulated shell assembly 13, the front face 17 of the socket 16a of a shell segment (such as shell segment 14b) is aligned with the rounded edge 25 of an adjacent shell segment (such as shell segment 14b). The rounded edge 25 of the ball 16b is configured to guide insertion of the socket 16a onto the ball 16b. The revolved interior surface 27 of the socket 16a is then pushed over the revolved exterior surface 29 of ball 16b. The socket 16a and/or ball 16b may deflect as the socket 16a translates over the ball 16b. Once the surface 21 of the ball 16b abuts the interior surface 23 of the socket 16a, the shell segments 14 are linked together, i.e., mated. Although not shown, an o-ring may be provided at the interface between the revolved interior surface 27 of the socket 16a and the revolved exterior surface 29 of ball 16b to limit the ingress of contaminants into the shell segments 14. The o-ring is an optional component of the design and may be omitted.

Although not shown, the revolved interior surface 27 of the socket 16a may include one or more openings, slots or slits to facilitate deflection of the socket 16a as it is pushed over the ball 16b. Moreover, the revolved exterior surface 29 of ball 16b may also include one or more openings, slots or slits to facilitate deflection of the ball 16b as the socket 16a is pushed over the ball 16b.

Each ball and socket joint is configured to permit rotation of adjacent shell segments 14. The revolved exterior surface 29 of the ball 16b is capable of rotating within the revolved interior surface 27 of the socket 16a. The rotation afforded by the ball and socket joint enables spooling of the pipeline 10 onto a reel.

Referring still to FIG. 2, the interior diameter D1 of the revolved interior surface 27 of the socket 16a is sized to tightly encapsulate the outer diameter D2 of the revolved exterior surface 29 of the ball 16b. The relative sizes of diameters D1 and D2 are tailored to limit inadvertent separation of mated shell segments 14, while permitting relative rotation of the mated shell segments 14. The maximum gap ‘G’ between the surfaces 21 and 23 is also tailored to permit relative rotation of the mated shell segments 14, while limiting interplay (e.g., clearance) between those shell segments 14. Excessive interplay between the assembled shell segments 14 could potentially create a weak point in the pipeline 10 upon spooling the pipeline 10 onto a reel. By way of example, the angle of rotation of one shell segment 14 with respect to an adjacent shell segment 14 may be about 0.5 to 2.5 degrees, for example. The radius of the balls 16b and the sockets 16a may be varied to achieve a desired bend radius of the pipeline 10.

A gap may exist between the inner surface of the shell segments 14 and the outer revolved surface of the fluid conduit 12. The size of the gap may vary from that shown and described herein without departing from the spirit and scope of the invention. The gap between the inner surface of the shell segments 14 and the outer revolved surface of the fluid conduit 12 is sufficiently large to permit relative rotation of the shell segments 14 if the conduit 12 is semi-rigid and to permit the fluid conduit 12 and the shell segments 14 to move somewhat relative to each other, yet is small enough to support and restrain the fluid conduit 12 when internal pressures are relatively high.

The length ‘L’ (see FIG. 2) of each shell segment may be any desired length. By way of example, the entire length of the pipeline 10 may be one to three kilometers, or any other desired length. The length ‘L’ of each shell segment impacts the total bend radius of the pipeline 10. Increasing the length ‘L’ of each shell segment increases the bend radius of the pipeline 10. The length of each shell segment may be tailored to meet a specific bend radius.

The outer diameter ‘D’ (see FIG. 1) of each shell segment may be about 0.125 inches to 10 inches, for example, or any other desired diameter. The diameter ‘D’ of each shell segment also impacts the total bend radius of the pipeline 10. Increasing the diameter ‘D’ of each shell segment increases the bend radius of the pipeline 10, and vice versa. The wall thickness of each shell segment may be about 0.1 inches to 0.75 inches, for example, or any other desired wall thickness.

Several ways exist to assemble the articulated shell 14 onto the fluid conduit 12. By way of example, the shell segments 14 may be assembled onto a free end of the fluid conduit 12 during manufacture of the pipeline 10 or at any time a free end of the fluid conduit 12 is readily available. If the fluid conduit 12 is already spooled on a reel, one method of assembling the shell segments 14 onto a spooled fluid conduit 12 is as follows: (i) assemble a string of shell segments 14 and spool the assembled shell segments 14 onto a second reel, (ii) feed a free end of the spooled fluid conduit into several shell segments 14, and (iii) unwind the fluid conduit 12 from its reel causing the fluid conduit 12 to travel through the assembled shell segments 14. Once the fluid conduit 12 has travelled through the assembled shell segments 14 the pipeline 10 is formed.

If for any reason, a free end of the fluid conduit 12 is not readily accessible, a shell segment 14 can not be assembled onto the fluid conduit 12 due to the closed geometrical shape of the shell segments 14. For at least that reason, a helical shell or a multi-piece shell segment may be particularly useful in instances where a free end of the fluid conduit 12 is not readily accessible. A multi-piece shell segment may also be particularly useful for replacing a damaged shell segment 14 with a new shell segment without having to remove all of the assembled shell segments 14 from the pipeline 10.

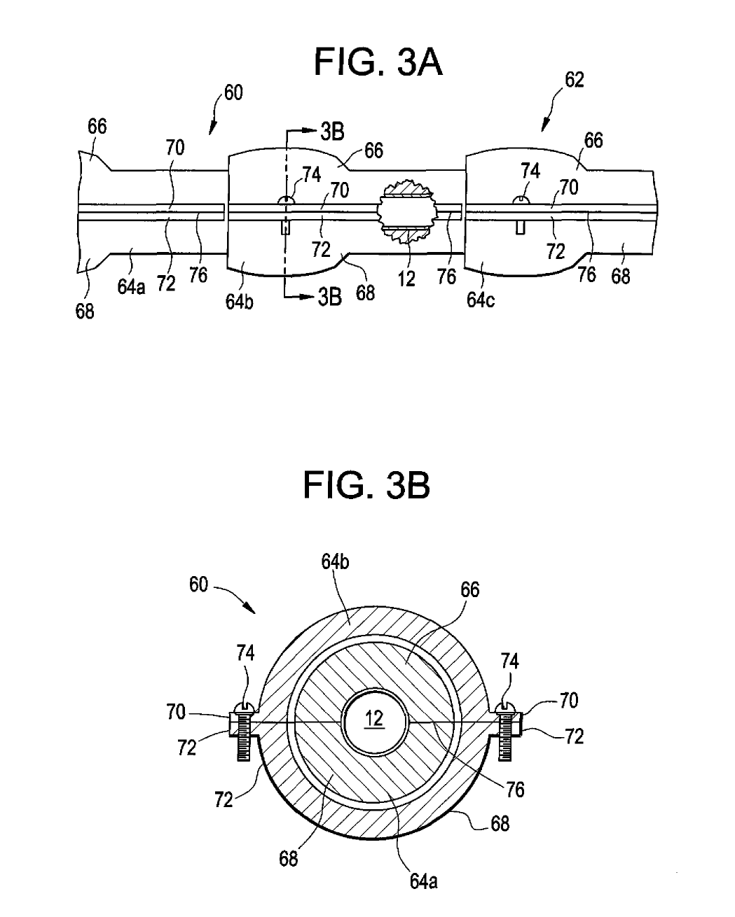

FIG. 3A depicts an elevation view of a segment of a pipeline 60 comprising a fluid conduit 12 that is encapsulated within an articulating shell assembly 62, according to another exemplary embodiment of the invention. The articulating shell assembly 62 comprises a series of interlinked articulated shell segments 64A-64C (collectively referred to as articulated shell segments 64). A portion of the shell segment 64B is cutaway to reveal the position of the fluid conduit 12. The pipeline segment 60 is substantially the same as the pipeline segment 10 of FIGS. 1 and 2, with the exception that each articulating shell segment 64 of FIG. 3A is a two-piece assembly. Like the shell segments 14a-14c of FIG. 1, the articulated shell segments 64A-64C interlock through a series of ball and socket joints such that the shell segments 64A-64C are capable of rotation with respect to one another.

FIG. 3B depicts a cross-sectional side view of the pipeline 60 of FIG. 3A taken along the lines 3B-3B. Each shell segment 64 comprises two portions 66 and 68 that are mated together either releasably or permanently. The shell segment portions 66 and 68 are substantially identical. The shell segment portions 66 and 68 include a semi cylindrical, revolved body and a flange 70 and 72, respectively. The flanges 70 and 72 have mating surfaces that are positioned to meet at a common interface 76. As best shown in FIG. 3A, the flanges 70 and 72 extend along a portion of the length of the shell segments 64 so as not to interfere with the ball and socket joint. The flanges 70 and 72 are optional features of the shell segment 64 and may be omitted.

A mechanical fastener 74, in the form of a self-threading mechanical screw, is engaged with both flanges 70 and 72 of each shell segment 64 to join the shell segment portion 66 to the shell segment portion 68 together. The fastener 74 is threadedly engaged with holes (not explicitly shown) that are provided in the flanges 70 and 72. Those skilled in the art will recognize that numerous ways exist to mount or join the shell segment portions 66 and 68 together. The shell segment portions 66 and 68 may also be mated together by a clip, a connector, a pin, a barb, a hook, a socket, an adhesive, a weld, a clamp, a rivet, a magnet, a bolt, a screw, or any other fastening mechanism known to those skilled in the art. Although not shown, an environmental gasket may be provided at the interface 76 between the shell segment portions 66 and 68 to limit the ingress of contaminants into the pipeline 60.

Although not shown, in lieu of fasteners 74, the shell segment portion 66 may include a barb extending from flange 70 and the shell segment portion 68 may include an aperture defined on flange 72 that is sized to receive the barb of the shell segment portion 66. Mating the barb with the aperture either permanently or releasably mates the shell segment portions 66 and 68 together. Depending upon the wall thickness of the portions 66 and 68, as well as the size of the barb and/or the aperture, the flanges 70 and 72 may be omitted.

Each two-piece articulating shell segment 64 may be assembled onto the fluid conduit 12 at any point along the length of the conduit 12 by virtue of the two-piece arrangement of the articulated shell segment 64. Such an embodiment of the shell segment is particularly advantageous in an instance where the fluid conduit 12 is already deployed in the field and a free end of the conduit 12 is not readily accessible. The two-piece articulating shell segment 64 is also useful for replacing a damaged shell segment 14 (see FIG. 1) with a new shell segment 64 without having to remove all of the assembled shell segments 14 from a pipeline.

According to another exemplary embodiment of the invention that is not illustrated herein, instead of each shell segment having both a ball and a socket as is depicted in FIGS. 1-3B, two types of shell segments are contemplated whereby one shell segment has a ball at each end and the other shell segment has a socket at each end. The shell segment types would be alternated along the length of the piping, forming a ball and socket joint at each interface.

Referring now to the material composition of the components of the pipelines 10 and 60, the shell segments disclosed herein may be composed of any metallic or polymeric material known to those skilled in the art, including thermoplastic as well as thermoset materials. The shell segments may be composed of OXPEKK® C40C which is manufactured by Oxford Performance Materials Inc. of Enfield, Conn., USA. By way of non-limiting example, other materials suitable for the shell segments include polyetheretherketone (PEEK) and polyetherketoneketone (PEKK), as well as other polyarylketones and polyaryletherketones, which are sufficiently rigid, rated for elevated temperatures (e.g., the continuous use temperature for PEKK is 500 degrees Fahrenheit) and are resistant to either acidic or basic chemicals. Illustrative examples of other suitable engineering thermoplastics include polyphenylene sulfides, polyphenylene oxides and polysulphones. Other structural plastics such as polycarbonates, polyamides, polyesters or polyacetals, for example, may be useful for less aggressive applications. Suitable thermoset materials include epoxy resins and polyester thermoset resins. The polymeric material may be compounded with any of the additives known in the art, such as fillers, reinforcing agents, stabilizers, processing aids and the like. The shell segments may be manufactured using any of the conventional fabrication techniques customarily utilized for shaping materials, including but not limited to injection molding and compression molding.

Referring now to material composition of the fluid conduit 12, the conduit 12 optionally includes a single layer that is composed of fiber reinforced OXPEKK® polyetherketoneketone which is manufactured by Oxford Performance Materials Inc. of Enfield, Conn., USA. By way of non-limiting example, other materials suitable for the fluid conduit 12 are plastics such as Polyvinylidene Fluoride (PVDF, including Kynar® PVDF), Polyolefins (such as Polypropylene), and Polyamides (such as Polyamide 11 or 12). In addition to one or more plastics, the conduit may be comprised of one or more other materials, such as metals, glass or other ceramic materials, as well as other inorganic substances (such as inorganic particulate fillers or carbon fibers), provided the conduit remains sufficiently flexible to permit the pipeline to be deployed in the field. These additional materials (which may be in the form of fibers, particles, wires, or mats, for example) may be embedded in or compounded into a plastic matrix. The material of the fluid conduit 12 may be tailored to enhance its structural integrity or static dissipation properties, for example. The fluid conduit 12 may be composed of any material that meets the following criterion: (i) suitable for fluid transport, (ii) sufficiently flexible for simple deployment of the pipeline in the field, and (iii) becomes sufficiently rigid when pressurized. Those skilled in the art will recognize that numerous materials meet the foregoing criterion.

Single-layer fluid conduits may be preferred as they are less expensive to manufacture. Alternatively, the fluid conduit 12 may comprise more than one layer depending upon the particular application. For example, double-layer fluid conduits are envisioned for use with a pipeline where the fluids outside of the conduit are of a different nature than the fluids travelling within the fluid conduit, such that no single material is impervious to both fluids. For example, if the fluids travelling along the interior of the conduit are acidic, but the fluids travelling along the exterior of the conduit are basic, the material of the interior layer of the fluid conduit would be resistant to acids, while the material of the exterior layer of the fluid conduit would be resistant to bases. In such an example, the interior layer of the double-layer fluid conduit may be composed of PVDF, whereas the exterior layer of the double-layer fluid conduit may be composed of polyolefin, for example.

Triple-layer fluid conduits are also envisioned for use with a pipeline where the fluids outside of the conduit are of a different nature than the fluids on the inside of the fluid conduit, such that no single material is impervious to both fluids. The internal layer (i.e., sandwiched between the exterior layer and the interior layer) can be employed as a tie layer in the event that the interior layer and/or the exterior layer of the conduit need be integrally attached. For applications where the bend radius of a pipeline need be maintained at a minimum, however, a triple-layer conduit may not be preferred because the third layer may reduce the flexibility of the pipeline. Other circumstances where a triple layer conduit might be advantageous is when an internal layer is needed as an additional barrier for complex fluids, such as gases that might penetrate the interior layer and/or the exterior layer. Additionally, a braid composed of Kevlar® aromatic polyamide fiber, for example, may be applied over the conduit for added protection.

Although the invention is illustrated and described herein with reference to specific embodiments, the invention is not intended to be limited to the details shown. While the pipelines disclosed herein might be particularly useful for the transport of fluids for chemical process and petroleum applications, they may be employed for any other application involving wires, lines, cables or conduits. As an example, the articulated shell segments may be applied over electrical cabling in an effort to prevent rodents from chewing, or otherwise harming, the electrical cabling. Various modifications may be made in the details within the scope and range of equivalents of the claims and without departing from the spirit of the invention.

1. An articulated pipeline assembly for the transport of fluids comprising:
a fluid conduit for transporting fluid; and
an articulating shell assembly that is positioned to encapsulate the fluid conduit, wherein the articulating shell assembly includes a plurality of articulating shell segments, each articulating shell segment comprising both a ball and a socket, wherein the ball of each articulating shell segment is engaged with a socket of an adjacent articulating shell segment to form a ball and socket joint and the socket of each articulating shell segment is engaged with a ball of an adjacent articulating shell segment to form a ball and socket joint,
wherein each articulating shell segment is configured to rotate with respect to an adjacent articulating shell segment by virtue of the ball and socket joint; and
wherein the ball of each articulating shell segment has a revolved exterior surface which includes one or more openings, slots or slits to facilitate deflection of the ball as the socket of the adjacent articulating shell segment is pushed over the ball.

2. An articulated pipeline assembly for the transport of fluids comprising:
a fluid conduit for transporting fluid; and
an articulating shell assembly that is positioned to encapsulate the fluid conduit, wherein the articulating shell assembly includes a plurality of articulating shell segments, each articulating shell segment comprising both a ball and a socket, wherein the ball of each articulating shell segment is engaged with a socket of an adjacent articulating shell segment to form a ball and socket joint and the socket of each articulating shell segment is engaged with a ball of an adjacent articulating shell segment to form a ball and socket joint,
wherein each articulating shell segment includes two discrete, separable components that are configured to be mated together.

3. An articulated pipeline assembly for the transport of fluids comprising:
a fluid conduit for transporting fluid; and
an articulating shell assembly that is positioned to encapsulate the fluid conduit, wherein the articulating shell assembly includes at least two articulating shell segments coupled together,
one of the at least two articulating shell segments comprising a ball at each end thereof and the other of the at least two articulating shell segments comprising a socket at each end thereof,
wherein the ball of an articulating shell segment is engaged with a socket of an adjacent articulating shell segment to form a ball and socket joint and the socket of an articulating shell segment is engaged with a ball of an adjacent articulating shell segment to form a ball and socket joint,
wherein each articulating shell segment is configured to rotate with respect to an adjacent articulating shell segment by virtue of the ball and socket joint.

4. The articulated pipeline assembly of claim 1, wherein the articulating shell segments are comprised of a material selected from the group consisting of polyarylketones and polyaryletherketones.

5. The articulated pipeline assembly of claim 1, wherein an o-ring is provided at the interface between the revolved interior surface of the socket and the revolved exterior surface of the ball to limit the ingress of contaminants into the articulated pipeline assembly.

6. The articulated pipeline assembly of claim 2, wherein the articulating shell segments are comprised of a material selected from the group consisting of polyarylketones and polyaryletherketones.

7. The articulated pipeline assembly of claim 2, wherein an environmental gasket is provided at the interface between the two discrete, separable components to limit the ingress of contaminants into the articulated pipeline assembly.

8. The articulated pipeline assembly of claim 2, wherein the two discrete, separable components are mated together using a mechanical fastener.

9. The articulated pipeline assembly of claim 2, wherein the two discrete, separable components are mated together using a barb extending from one component and an aperture in the other component that is sized to receive the barb.

10. The articulated pipeline assembly of claim 2, wherein the two discrete, separable components are releasably mated together.

11. The articulated pipeline assembly of claim 2, wherein each of the two discrete, separable components include a semi cylindrical, revolved body and a flange wherein the flanges have mating surface that are positioned to meet at a common interface.

12. The articulated pipeline assembly of claim 2, wherein an o-ring is provided at the interface between the revolved interior surface of the socket and the revolved exterior surface of the ball to limit the ingress of contaminants into the articulated pipeline assembly.

13. The articulated pipeline assembly of claim 3, wherein each ball of the articulating shell segment comprising a ball at each end thereof has a revolved exterior surface which includes one or more openings, slots or slits to facilitate deflection of the ball as the socket of the adjacent articulating shell segment is pushed over the ball.

14. The articulated pipeline assembly of claim 3, wherein each socket of the articulating shell segment comprising a socket at each end thereof has a revolved interior surface which includes one or more openings, slots or slits to facilitate deflection of the socket as the socket is pushed over the ball of the adjacent articulating shell segment.

15. The articulated pipeline assembly of claim 3, wherein an o-ring is provided at the interface between the revolved interior surface of the socket and the revolved exterior surface of the ball to limit the ingress of contaminants into the articulated pipeline assembly.

16. The articulated pipeline assembly of claim 3, wherein the articulating shell segments are comprised of a material selected from the group consisting of polyarylketones and polyaryletherketones.
